(19) United States
(12) Patent Application Publication
(10) Pub. No.: US 2014/0022336 A1
(43) Pub. Date: Jan. 23, 2014

(54) CAMERA DEVICE

(71) Applicants: Mang OU-YANG, Hsinchu City (TW); Wei-De JENG, Taoyuan County (TW); Chien-Cheng LAI, Taichung City (TW); Yi-Chiun KUNG, Kaohsiung City (TW); Kuan-Heng TAO, Kaohsiung City (TW); Jin-Chern CHIOU, Hsinchu City (TW); Hsien-Ming WU, Taoyuan County (TW)

(72) Inventors: Mang OU-YANG, Hsinchu City (TW); Wei-De JENG, Taoyuan County (TW); Chien-Cheng LAI, Taichung City (TW); Yi-Chiun KUNG, Kaohsiung City (TW); Kuan-Heng TAO, Kaohsiung City (TW); Jin-Chern CHIOU, Hsinchu City (TW); Hsien-Ming WU, Taoyuan County (TW)

(21) Appl. No.: 13/613,559

(22) Filed: Sep. 13, 2012

(30) Foreign Application Priority Data
Jul. 17, 2012 (TW) 101125630

(51) Int. Cl. H04N 13/02; H04N 7/00

(52) U.S. Cl. 348/36; 348/46; 348/E13.074; 348/E07.001

(57) ABSTRACT

A camera device comprises more than three image capture modules used to capture more than perspective images of a 3D (3-dimensional) object; and an administration module electrically connecting with the image capture modules, receiving and administrating the perspective images of the 3D object. The present invention uses the image capture modules to capture the perspective images of the 3D object from different shooting angles and synthesizes the perspective images of the 3D object into a 3D panoramic image of the 3D object. Besides, the present invention can precisely obtain the dimensional information, such as the size, length and width, of the object in the image. Therefore, present invention can effectively promote the quality of 3D panoramic images of a 3D object.

### BACKGROUND OF THE INVENTION

1. Field of the Invention

The present invention relates to a camera device, particularly to a camera device able to obtain a plurality of perspective images of a 3D object or a 3D scene.

2. Description of the Related Art

The 3-dimensional (3D) vision of human beings has long been a subject of science research from ancient to now. Originally, the study of 3D vision was focused on the binocular disparity. Recently, the focus of 3D vision has gradually turned to using the information of 2-dimensional (2D) images to present 3D images. For example, both the 3D camera and the 3D camcorder can present the captured images in a 3D way and have assumed their places in the market. Refer to FIG. 1a. A 3D camera normally uses a first lens 10 and a second lens 12, which are arranged parallel, to simulate the human eyes. The first lens 10 and the second lens 12 respectively capture a first 2D image 14 and a second 2D image 16. A slight disparity exists between the first 2D image 14 and the second 2D image 16, whereby the two 2D images can be synthesized into a 3D image.

Refer to FIG. 1b. The abovementioned technology can only form the 3D image on a single view plane, such as the plane represented by the segment P. In other words, the viewer can only watch the 3D image from a specified position. While the viewer tilts his head by an angle (denoted by the dotted line Q), he cannot appreciate the 3D effect any more. Therefore, the conventional 3D camera technology is limited in application and hard to popularize.

Accordingly, the present invention proposes a camera device to overcome the abovementioned problems.

### SUMMARY OF THE INVENTION

The primary objective of the present invention is to provide a camera device, which captures a plurality of perspective images of a 3D object (or a 3D scene) and uses the perspective images to construct a 3D panoramic image, whereby is promoted the quality of 3D images.

Another objective of the present invention is to provide a camera device, which makes use of a plurality of perspective images of a 3D object to obtain the precise dimensional information (such as size, length, and width) of the object, and which applies to the medical endoscope, the industrial endoscope and the electronics presenting 3D panoramic images.

To achieve the abovementioned objectives, the present invention proposes a camera device, which comprises more than three image capture modules capturing more than three perspective images of a 3D object; and an administration module electrically connecting with the image capture modules, receiving and administrating the perspective images of the 3D object. The administration module synthesizes the perspective images of the 3D object into a 3D panoramic image of the 3D object and transmits the 3D panoramic image to an external processing module in a wired or wireless way. Then, the external processing module displays the 3D panoramic image. Thereby, the user can view the 3D panoramic image in realtime. Alternatively, the perspective images of the 3D object are transmitted to the external processing module and synthesized into a 3D panoramic image by the external processing module, whereby can be realized the miniaturized camera devices applicable to various fields. Further, the present invention can reduce the amount of image processing. Therefore, the present invention has a superior potential in the market.

Below, embodiments are described in detail to make easily understood the objectives, technical contents, characteristics and accomplishments of the present invention.

### BRIEF DESCRIPTION OF THE DRAWINGS

FIG. 1a schematically shows a conventional 3D camera;

FIG. 1b schematically shows that the perspective images captured by the 3D camera in FIG. 1;

FIG. 2 is a block diagram schematically showing the architecture of a camera device according to a first embodiment of the present invention;

FIG. 3 is a block diagram schematically showing the architecture of a camera device according to a second embodiment of the present invention;

FIG. 4 schematically shows that three image capture modules are used to capture perspective images of a 3D object according to a third embodiment of the present invention;

FIGS. 5a-5c schematically show that the three image capture modules in FIG. 4 respectively capture three perspective images of a 3D object from different shooting angles;

FIG. 6 schematically shows that four image capture modules are used to capture perspective images of a 3D object according to a fourth embodiment of the present invention; and

FIG. 7 schematically shows that five image capture modules are used to capture perspective images of a 3D object according to a fifth embodiment of the present invention.

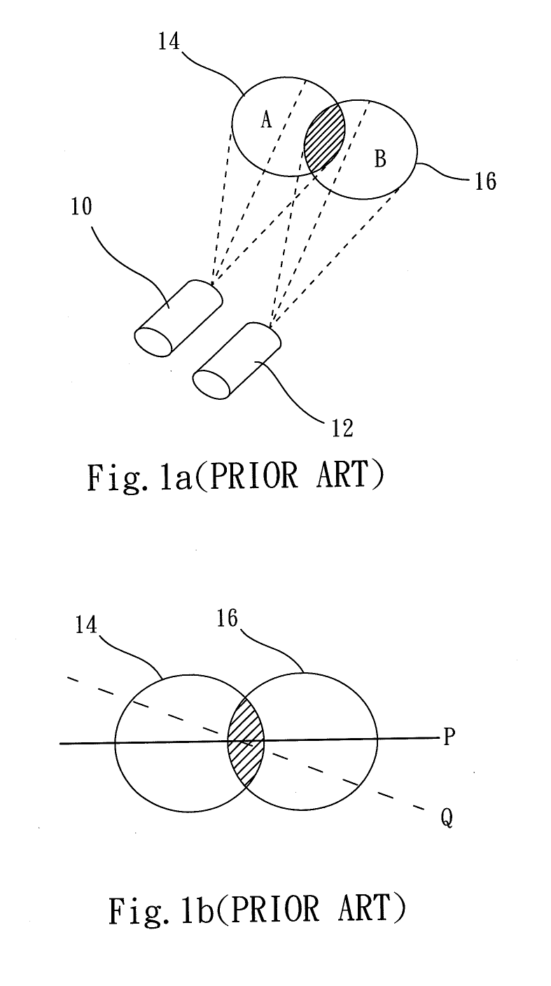

### DETAILED DESCRIPTION OF THE INVENTION

In order to overcome the drawback of the conventional technology that can only generate a perspective image of a 3D object, the present invention discloses a breakthrough technology able to construct a 3D panoramic image of a 3D object and provide a feeling of a physical 3D world for the users, whereby is realized the longtime dream of human beings and satisfied the requirement of various industries.

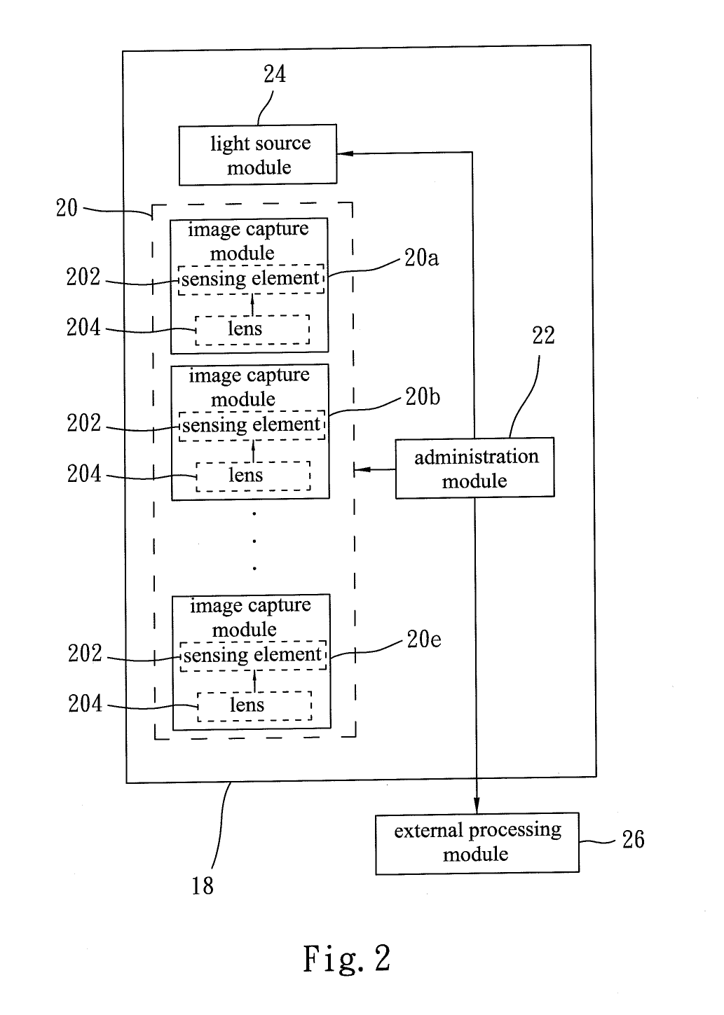

Refer to FIG. 2 a block diagram schematically showing the architecture of a camera device according to a first embodiment of the present invention. The camera device 18 of the present invention comprises more than three image capture modules 20, an administration module 22 and a light source module 24. Each image capture module 20 includes at least one sensing element 202 and a lens 204 connecting with the sensing element 202. The sensing element 202 is a charge-coupled device (CCD) or a CMOS (Complementary Metal Oxide Semiconductor) device. In operation, the administration module 22 controls the light source module 24 (such as LEDs) to project light on a 3D object. The lenses 204 of at least two image capture modules 20 capture the light reflected from the object; the sensing elements detect the reflected light and generate perspective images of the 3D object. In other words, more than three image capture modules 20 can obtain more than three perspective images of the 3D object. The administration module 22 receives and administrates the perspective images. In one embodiment, the administration module 22 directly processes the perspective images and synthesizes them into a 3D panoramic image of the 3D object. Then, the 3D panoramic image is transmitted to an external processing 26 module and presented by the external processing module 26. The external processing module 26 is an electronic device able to present a 3D panoramic image, such as a computer or PDA.

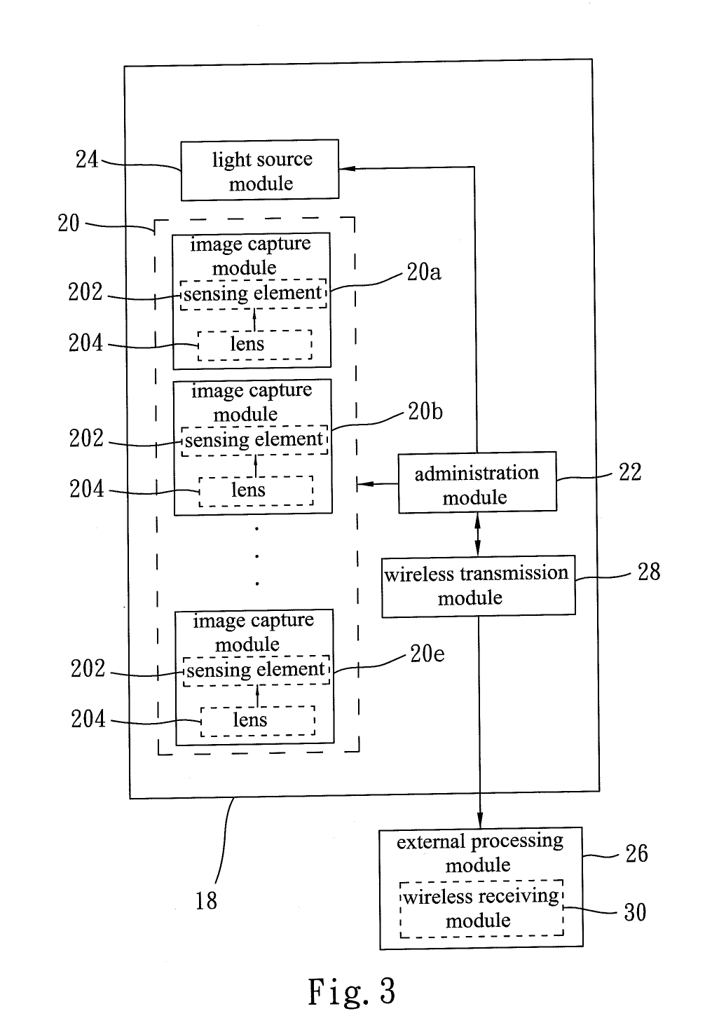

Refer to Refer to FIG. 3 a block diagram schematically showing the architecture of a camera device according to a second embodiment of the present invention. In the second embodiment, the camera device 18 further comprises a wireless transmission module 28; the external processing module 26 further comprises a wireless receiving module 30. The administration module 22 receives the perspective images of a 3D object from the image capture modules 20 and administrates the perspective images. The administration module 22 uses the wireless transmission module 28 to transmit the perspective images to the wireless receiving module 30 in a wireless way. The external processing module 26 receives the perspective images of the 3D object via the wireless receiving module 30 and processes the perspective images to form a 3D panoramic image of the 3D object. Then, the external processing module 26 presents the 3D panoramic image.

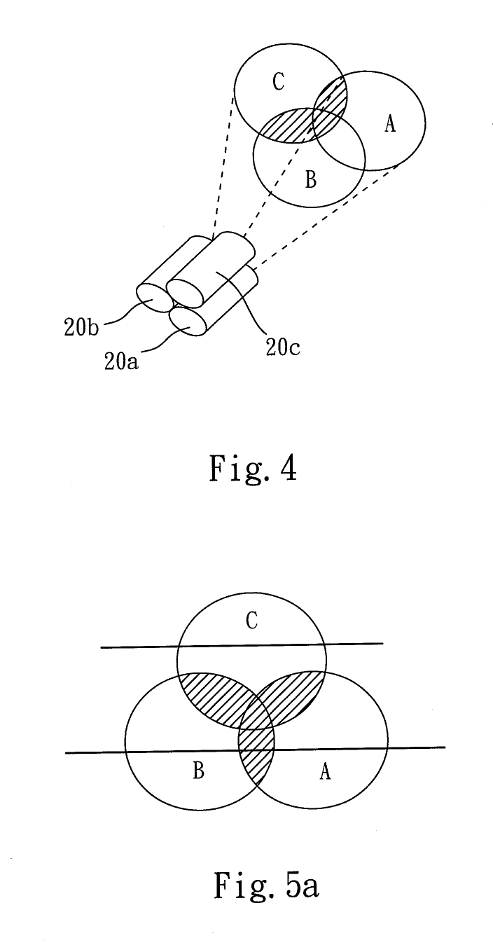

Refer to FIG. 4 schematically showing that three image capture modules are used to capture three perspective images of a 3D object according to a third embodiment of the present invention. The three image capture modules are image capture modules 20a, 20b and 20c. The image capture modules 20a and 20b are arranged in a horizontal plane. The image capture device 20c is arranged above the image capture modules 20a and 20b. Viewed from the front, the image capture modules 20a, 20b and 20c form a triangle. The three image capture modules 20a, 20b and 20c respectively capture three perspective images A, B and C of a 3D object (or a 3D scene).

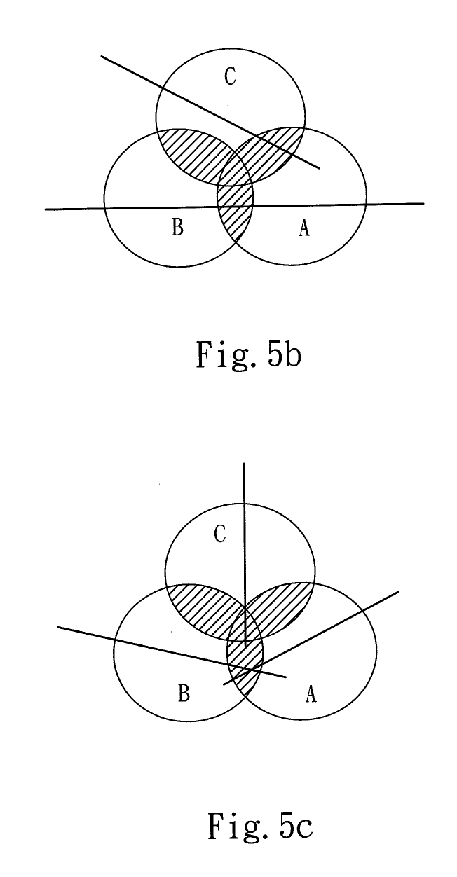

Refer to FIGS. 5a-5c schematically showing that the three image capture modules 20a, 20b and 20c respectively capture three perspective images A, B and C of a 3D object. As shown in FIG. 5a, the three image capture modules 20a, 20b and 20c shoot from an identical shooting angle, and thus respectively capture three perspective images A, B and C of the same shooting angle. As shown in FIG. 5b, the image capture modules 20a and 20b shoot from an identical shooting angle, and the image capture module 20c shoots from another shooting angle. Thus, the image capture modules 20a and 20b respectively capture two perspective images A and B of the same shooting angle; the image capture module 20c captures a perspective image C of another shooting angle. As shown in FIG. 5c, the three image capture modules 20a, 20b and 20c respectively shoot from three different shooting angles, and thus respectively capture three perspective images A, B and C of different shooting angles.

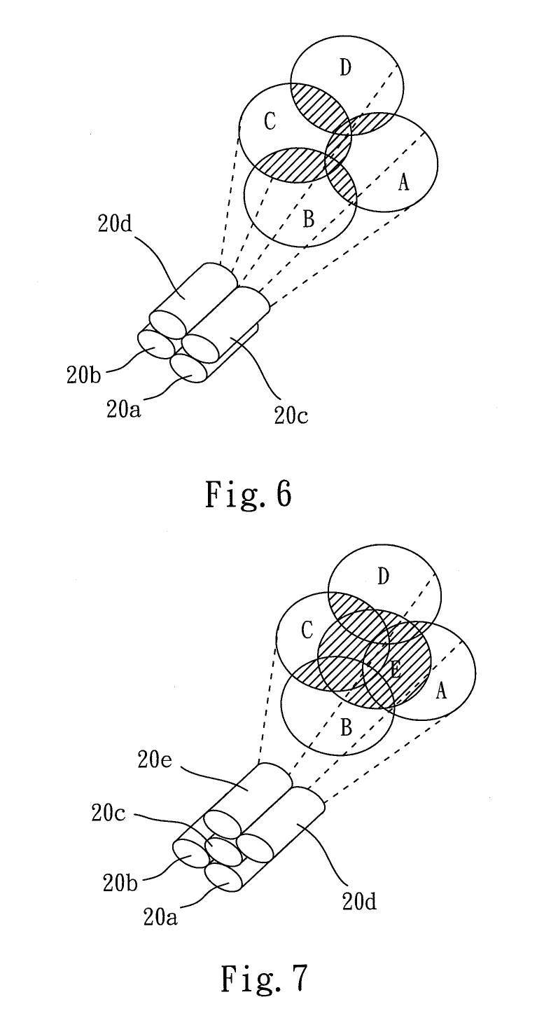

Refer to FIG. 6. An image capture module 20d is added to the three image capture modules 20a, 20b and 20c, whereby are obtained more than three perspective images of the 3D object. In FIG. 6, the image capture modules 20a and 20b are arranged in a horizontal plane, and the image capture modules 20c and 20d are arranged in another horizontal plane. Then, the image capture modules 20c and 20d are arranged above the image capture modules 20a and 20b. In one embodiment, the four image capture modules shoot from an identical shooting angle. In one embodiment, three of the four image capture modules shoot from an identical shooting angle, and the residual one shoots from another shooting angle. In one embodiment, two of the four image capture modules shoot from a shooting angle, and the other two shoot from another shooting angle. In one embodiment, the four image capture modules respectively shoot from four different shooting angles. Therefore, the four image capture modules can capture more than three perspective images of the 3D object, which respectively have different shooting angles. The four image capture modules can capture at most six perspective images of the 3D object, which respectively have different shooting angles.

Refer to FIG. 7. There are totally five image capture modules 20a, 20b, 20c, 20d and 20e. In FIG. 7, the image capture modules 20a and 20b are arranged in a horizontal plane; the image capture module 20c is arranged above the image capture modules 20a and 20b; the image capture modules 20d and 20e are arranged in another horizontal plane and above the image capture module 20c. The shooting angles of the five image capture modules can be adjusted independently and arbitrarily to obtain more than five perspective images A, B, C, D and E of a 3D object, which respectively have different shooting angles. The five image capture modules can capture at most ten perspective images of a 3D object, which respectively have different shooting angles, wherein each shooting angle ranges from 60 to 140 degrees.

The more the perspective images captured from different shooting angles, the more precise the 3D panoramic image constructed therefrom. The present invention can obtain the required perspective images of a 3D object via varying the number, installation positions and shooting angles of the image capture modules. Therefore, the present invention can upgrade the quality of 3D panoramic images.

The present invention is applicable to the medical endoscope, the industrial endoscope and the electronics presenting 3D panoramic images. For the application to the medical endoscope, the camera device of the present invention can be miniaturized into a capsular endoscope, which may be used to image the stomach or the intestines. After the patient has swallowed the capsular endoscope, the administration module of the capsular endoscope (camera device) controls the light source module to project light on the tissue of the stomach or intestines. More than three image capture modules are adjusted to have appropriate shooting angles. Next, the sensing elements of the image capture modules receive the light reflected from the stomach or intestines and generate more than three perspective images respectively having different shooting angles. Then, the administration module synthesizes the perspective images into a 3D panoramic image. Alternatively, the administration module wirelessly transmits the perspective images to an external processing module able to synthesize the perspective images into a 3D panoramic image. The present invention is characterized in capturing several perspective images respectively from different shooting angles and thus favors acquiring the dimensional information of a 3D object, such as the size, length and width of a tumor. Further, the capsular endoscope realized by the present invention is free of blind spots that the conventional capsular endoscope is likely to have.

The 3D TV is an emerging technology providing solid and high-definition images. However, the user can only watch the images of a 3D TV from a specified position. The camera device of the present invention can provide a plurality of perspective images respectively having different shooting angles and thus enables the user to watch a 3D TV from different positions. Therefore, the present invention has very high potential in the market.

The embodiments described above are only to exemplify the present invention but not to limit the scope of the present invention. Any equivalent modification or variation according to the characteristic or spirit of the present invention is to be also included within the scope of the present invention.

What is claimed is:

1. A camera device comprising more than three image capture modules used to capture more than three perspective images of a 3D (3-dimensional) object; and
an administration module electrically connecting with said image capture modules, receiving and administrating said perspective images of said 3D object.

2. The camera device according to claim 1, wherein each said image capture module includes at least one sensing element and a lens connecting with said sensing element.

3. The camera device according to claim 2 further comprising a light source module electrically connecting with said administration module and controlled by said administration module to project light on said 3D object, wherein said lenses of at least two said image capture modules capture light reflected from said 3D object, and said sensing elements detect said light reflected from said 3D object to generate said perspective images of said 3D object.

4. The camera device according to claim 2, wherein said sensing element is a charge-coupled device (CCD) or a CMOS (Complementary Metal Oxide Semiconductor) device.

5. The camera device according to claim 1, wherein said three image capture modules are arranged to respectively capture said perspective images of said 3D object from different shooting angles.

6. The camera device according to claim 5, wherein each said shooting angle ranges from 60 to 140 degrees.

7. The camera device according to claim 1, wherein said administration module synthesizes said perspective images of said 3D object into a 3D panoramic image of said 3D object.

8. The camera device according to claim 7 further comprising a wireless transmission module, wherein said administration module uses said wireless transmission module to transmit said 3D panoramic image of said 3D object to an external processing module in wireless way, and wherein said external processing module displays said 3D panoramic image.

9. The camera device according to claim 8, wherein a transmission cable connects said administration module with said external processing module.

10. The camera device according to claim 1, wherein said administration module uses a wireless transmission module to transmit said perspective images of said 3D object to an external processing module in a wireless way, and wherein said external processing module synthesizes said perspective images of said 3D object into a 3D panoramic image of said 3D object.
